(19) United States
(12) Patent Application Publication
(10) Pub. No.: US 2022/0120379 A1
(43) Pub. Date: Apr. 21, 2022

(54) Stabilizing Support for an Item

(71) Applicant: Raelana Williams, Kaneohe, HI (US)

(72) Inventor: Raelana Williams, Kaneohe, HI (US)

(21) Appl. No.: 17/482,592

(22) Filed: Sep. 23, 2021

Related U.S. Application Data
(60) Provisional application No. 63/093,501, filed on Oct. 19, 2020.

(51) Int. Cl. F16M 13/02; F16B 47/00

(52) U.S. Cl. CPC F16M 13/022; F16B 47/00

(57) ABSTRACT

This present invention relates to an item holding apparatus for securely holding household items, consumer products and electronic devices. The holding apparatus has a geometric shape that is easily portable and secures different types of items or objects. The holding apparatus features a base having a top surface, a bottom surface and side surfaces. The apparatus has suction cups for attaching to a surface, C-shaped clamps or hooks connected to extendable and retractable bands, and a spring mechanism for retracting each extendable and retractable band. The C-shaped clamps fit onto rim or edge of an item positioned on the base for securely holding by the device holding apparatus and the bands provide a centering force for the consumer product.

### CROSS-REFERENCE TO RELATED APPLICATION

The present application claims priority to, and the benefit of, U.S. Provisional Application No. 63/093,501, which was filed on Oct. 19, 2020 and is incorporated herein by reference in its entirety.

### FIELD OF THE INVENTION

The present invention relates generally to the field of auxiliary supports and aids for consumer products. More specifically, the present invention relates to a stabilizing support or holder for use with plates, cups, bowls, consumer products, mobile phones and other household items. The stabilizing holder comprises a geometrically-shaped base having one or more suction cups on its rear surface to maintain stabilization of any item placed on the top surface of the base. A number of C-shaped clamps or hooks are provided on each side of the base, such that the clamps can be extended out of the sides of the base to hold any household or consumer item, such as a plate, cup, bowl, mobile device or other device from four different sides. The clamping mechanism, along with the suction cup structure, provides a firm grip over the household or consumer item which is being held by the stabilizing holder, and prevents the items from being knocked over or falling from the position where they have been placed. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various household and other consumer items such as cups, plates, mugs, bowls, portable devices, mobile phones and additional products, such as those which are used to serve drinks, beverages, food items, and the like. Food items, consumable products and/or drinks are commonly served in serving vessels, such as plates, bowls, cups, saucers or other similar containers, and are placed on a tabletop or counter surface while accessing the food items and drinks provided within the vessel or container. However, keeping the food and beverage items stable on a tabletop or counter surface can often be difficult. Even with a slight push, the cups or mugs filled with beverages or other contents or plates or bowls with food items are at a risk of being knocked over, which may lead to the spilling of food items and beverages, ultimately creating a mess. This puts an additional burden on the individuals to clean the spilled over food and beverages, and leads to the wastage of these consumable items as well.

People are required to be extra careful while using serving vessels such as cups, plates, and other household items. Especially in houses with kids or small children, there is always a chance of cups, plates, or other household items being accidently knocked over, thereby damaging utensils and wasting the food items/beverages kept in the utensils. In addition, small children may deliberately push their food away if it is not held securely in position.

Additionally, individuals face problems and other difficulties in keeping personal items such as phones in an easily accessible location. Usually people need to access their phones frequently, and may desire to keep such personal items in a location that is quickly and easily accessible to them. However, due to lack of any specific holding and/or positioning capabilities for such personal items, people may often forget to keep their personal items near them and are then forced to have to go look for such items.

Various kinds of item holders exist in the state of the art, such as cup holders designed to hold cups, and the like. Although such holders hold the cups filled with beverages, they are at a risk of being knocked over, which ultimately creates a mess when the contents are spilled. The existing holders fail to fully stabilize the utensils and guard against a slight accidental push, which can lead to damaging of the utensils and wasting of the food or beverages contained in the vessel or container. Also, a single holder device, for example a cup holder, may not accommodate utensils of different sizes and shapes, and users are then required to buy multiple holders to handle a variety of different items.

Therefore, there exists a long felt need in the art for a stabilizing support for holding and securing an item such as, but not limited to, cups, mugs, plates, mobile devices and other household items, in a position or location desired by the user. There is also a long felt need in the art for a stabilizing device for household items that stabilizes the household or consumer item on a tabletop, counter or other surface. Additionally, there is a long felt need in the art for a holding, securing and stabilizing device that prevents the device that it is holding from being knocked over and/or spilling the contents of the device, and that enables users to keep their phones and other personal items near them and at an easily accessible location. Furthermore, there is a long felt need in the art for a holding device which can accommodate household and consumer items and other personal items of different shapes and sizes, thereby eliminating the need to buy multiple holding devices for securing different household and personal items. Finally, there is a long felt need in the art for a stabilizing support for an item that is relatively inexpensive to manufacture, and that is both safe and easy to use.

The subject matter disclosed and claimed herein, in one embodiment thereof, comprises a device-holding apparatus for securely holding household items, consumer products and electronic devices. The holder device has a geometrically-shaped structure that is easily portable and is able to secure different types of items or objects to a surface. The device holding or securing apparatus further includes, in one embodiment, a generally rectangular or square base having a top surface, a bottom surface and four side surfaces. More specifically, the generally rectangular, quadrate or square base has a number of suction cups attached to the bottom surface. The cups may be attached at each corner, or may be disposed in different configurations on the bottom of the surface. A C-shaped clamp is connected to an extendable and retractable band, which extends from each side surface. A spring mechanism is positioned within the base for retracting each extendable and retractable band, and the C-shaped clamps extend from each side surface of the base fit onto the outer rim or edge of an item positioned on the top surface for securely holding the device in position by the holding apparatus. The extendable bands are retracted automatically and positioned to the side surfaces when the apparatus is not used for holding any item.

In this manner, the novel stabilizing holder of the present invention accomplishes all of the forgoing objectives, and provides a relatively safe and convenient solution to hold and stabilize household items such as cups, plates or the like on a tabletop or counter surface, and prevent the cups, plates, containers and vessels from being knocked over and spilling of the contents. The stabilizing holder of the present invention can also be used to hold other personal and consumer items, such as mobile phones, at an easily accessible location.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a stabilizing support for securely holding a household, consumer and/or electronic device in a desired position. The holder device has a geometrically-shaped base structure that is easily portable and secures different types of items or objects. The device holding apparatus further includes a generally flat top surface, a bottom surface and one or more side surfaces. More specifically, the base has one or more suction cups that are attached to the bottom surface. A C-shaped clamp is connected to an extendable and retractable elastic band, and extends from each side surface. A spring mechanism is positioned within the base for retracting each extendable and retractable band, and the C-shaped clamps extend from each side surface of the base, and fit onto the rim or edge of an item positioned on the top surface, for secure holding by the device-holding apparatus. The extendable bands are retracted automatically and positioned adjacent to the side surfaces when the apparatus is not used for holding any item so that the bands do not interfere with the transport of the holding base, or when initially placing an item on the base for securement.

In a further embodiment of the present invention, a multipurpose holding apparatus for holding an item or an object is disclosed. The apparatus includes a generally square base having a top surface, a bottom surface and four side surfaces. Each side surface has an opening from which an extendable band is accessed, and a C-shaped clamp connected to an end of the extendable band with the other end abutting against the side surface. The bottom surface has one or more suction cups to secure the apparatus to a surface or a wall. In use, the extendable bands are pulled, and thus extended, and the C-shaped clamps of the apparatus fit onto an item placed on the top surface to secure and provide for stable storage of the item. After use, the extendable bands are automatically retracted and are stored within the base in band spools using the spring and stop mechanism.

In a further embodiment of the present invention, the holding apparatus can be used as a storage and stabilization system for plates, cups, bowls, vessels, mobile devices and other household items. The apparatus offers a way to store and mount other personal items, like a smartphone, onto a table, wall, or other surface. Following use, the apparatus can be stored in a carry bag for easy transport.

In a further embodiment of the present invention, a method for securing an item or object is described. The method comprises the initial step of positioning an item-holding apparatus on a surface or a wall. Next, positioning the item on a top surface of the item holding apparatus, and then, pulling one or more C-shaped hooks from each side surface of the apparatus to fit onto the rim or edge or any other suitable surface of the item to secure the item on the base of the apparatus. The C-shaped hooks are connected to extendable bands, which are extended from the band spools positioned within the base of the apparatus, and provide secure holding of the item when placed on the base. After use, the extendable bands are automatically retracted and are stored within the base in band spools using the spring and stop mechanism and forming a coiled band.

The holding apparatus, also referred to as universal holder and stabilization device, is a multipurpose apparatus capable of adapting to, securing and stabilizing different household, consumer and personal items. The apparatus prevents items from being knocked over by children, the elderly, special needs individuals and more as well as inadvertent acts by the individual placing the device on the holder or those in the area where the device was initially positioned or placed.

The item-holding apparatus of the present invention can be commercially available in different sizes and colors with retainer C-shaped hooks or clamps. The apparatus eliminates the worry of infants and toddlers accidentally knocking items off a table to create messes, or the risk of losing the item, and also is able to secure beverage containers with beverages contained therein. Through the use of one or more suction cups, the apparatus can be placed on a tabletop, countertop, desk, wall or other flat surface.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of the stabilizing support of the present invention in accordance with the disclosed architecture, wherein the repositionable straps are in a first or stowed position;

FIG. 2 illustrates a bottom perspective view of one potential embodiment of the stabilizing support of the present invention in accordance with the disclosed architecture, wherein the repositionable straps are in a first or stowed position;

FIG. 3 illustrates a top perspective view of one potential embodiment of the stabilizing support of the present invention in accordance with the disclosed architecture, wherein the repositionable straps are in a second or extended position;

FIG. 4A illustrates a perspective view of one potential embodiment of the stabilizing support of the present invention in accordance with the disclosed architecture, wherein the repositionable straps are in a second or extended position and about to receive a smartphone;

FIG. 4B illustrates a perspective view of one potential embodiment of the stabilizing support of the present invention in accordance with the disclosed architecture, wherein the support is securing the smartphone of FIG. 4A;

FIG. 5 illustrates a perspective view of one potential embodiment of the stabilizing support of the present invention in accordance with the disclosed architecture, wherein the support is securing a cup holding a beverage;

FIG. 6 illustrates a perspective view of one potential embodiment of the stabilizing support of the present invention in accordance with the disclosed architecture, wherein the support is securing a mug holding a beverage;

FIG. 7 illustrates a perspective view of one potential embodiment of the stabilizing support of the present invention in accordance with the disclosed architecture and an accompanying carrying case; and

FIG. 8 illustrates a perspective view of one potential embodiment of the spring mechanism of the stabilizing support of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments can be combined.

As noted above, there is a long felt need in the art for a stabilizing support for an item such as, but not limited to, a cup, mug, plate, mobile device or other household item in a position or location desired by the user. There is also a long felt need in the art for a stabilizing device for household items that stabilizes the household or consumer item on a tabletop, counter or other surface. Additionally, there is a long felt need in the art for a holding, securing and stabilizing device that prevents the device that it is holding from being knocked over and/or spilling the contents of the device, and that enables users to keep their phones and other personal items near them and at an easily accessible location. Furthermore, there is a long felt need in the art for a holding device which can accommodate household and consumer items and other personal items of different shapes and sizes, thereby eliminating the need to buy multiple holding devices for securing different household and personal items. Finally, there is a long felt need in the art for a stabilizing support for an item that is relatively inexpensive to manufacture, and that is both safe and easy to use.

The present invention, in one exemplary embodiment, is a novel stabilizing support for securely holding household items and electronic devices in a place selected by the user. The holder device has a geometrically-shaped configuration which may include a generally rectangular, quadrate, or square-shaped structure that is easily portable and which can be readily secured to different types of items or objects. The device holding apparatus in one embodiment further comprises a generally rectangular, quadrate, or square base having a top surface, a bottom surface and in this embodiment four side surfaces. More specifically, the generally rectangular or square base has four suction cups attached to the bottom surface. A C-shaped clamp is connected to an extendable and retractable band that extends from each side surface. A spring mechanism is positioned within the base for retracting each extendable and retractable band. The C-shaped clamps extend from each side surface of the base and are configured so as to fit onto rim or edge of an item positioned on the top surface for securely holding by the device holding apparatus. The extendable bands are retracted automatically and positioned to the side surfaces when the apparatus is not used for holding any item. By placing the bands on the upper surface or rim of the container or vessel, the bands provide a force anchoring the container or vessel to the base or platform. The C-shaped clamps may be further provided with a soft foam or rubber-like material, so as to not chip the edges of the vessel or container to which the bands are attached.

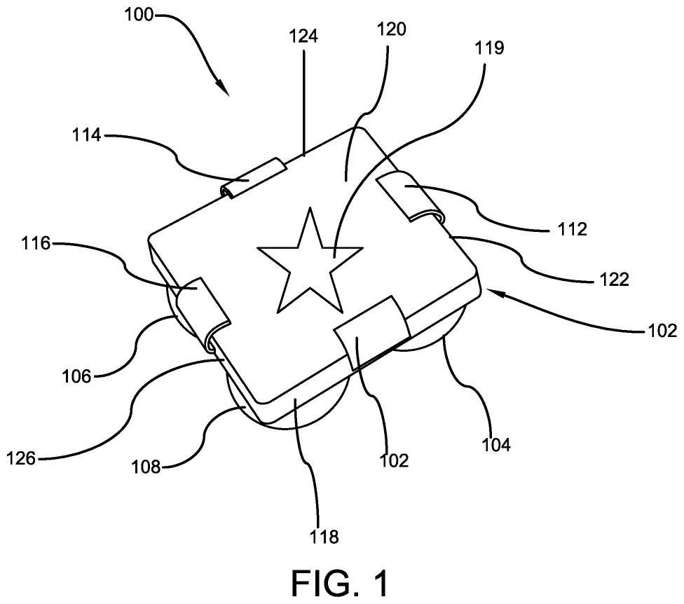

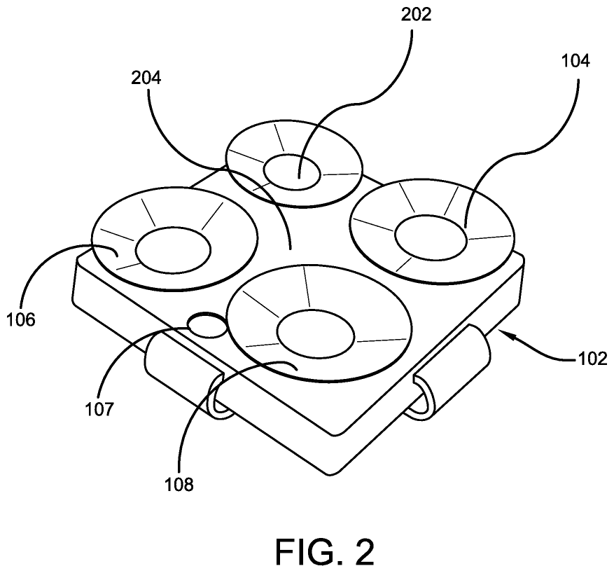

Referring initially to the drawings, FIG. 1 illustrates a top perspective view of one potential embodiment of the stabilizing support 100 of the present invention in accordance with the disclosed architecture, wherein the repositionable straps of the support 100 are in a first or stowed position. The stabilization support device 100 of the present invention is a multipurpose adapter system that is capable of securing and stabilizing a variety of different sized and shaped items. The device 100 has a geometrically-shaped base which may be a generally square or quadrate-like base 102 having a top surface 120 and a bottom surface 204 (shown in FIG. 2). Each side surface of the base 102 has an opening around the center of the side surfaces, from which a retractable C-shaped hook is accessible.

By providing the openings in a generally centrally-disposed area, the bands apply equal force in holding the container or vessel to the base of the device. A first C-shaped clamp 110 is accessible from a first side surface 118, a second C-shaped clamp 112 is accessible from a second side surface 122, a third C-shaped clamp 114 is accessible from a third side surface 124 and a fourth C-shaped clamp 116 is accessible from a fourth side surface 126. Each C-shaped clamp 110, 112, 114, 116 is attached to an elastic and extendable band, for extension to secure an item or object. Where different geometrically-shaped bases are provided, such as a triangle, hexagon, pentagon, circle or any other suitable shape, the bands and opening are equally-spaced around the edges of the shaped item.

The bottom surface of the base 120 has four similar and symmetrically-placed suction cups 104, 106, 108, 202 (as best shown in FIG. 2) for placing the device 100 on a surface in a stable and secure manner. The suction cups 104, 106, 108, 202 can be easily placed and removably fixed to a tabletop, countertop, desk, wall or other flat or smooth surface. Any object can be placed on the top surface 120 of the base 102 and each C-shaped clamp 110, 112, 114, 116 can be extended from each side surface and wrapped around an object or item to secure it to the base 102. The C-shaped clamps 110, 112, 114, 116 can abut any surface or edge of the object to be secured and placed on the top surface 120 of the base. The four clamps 110, 112, 114, 116 are designed such as to give a stable placement to any object placed on the top surface 120 of the base 102 of the device 100. The clamps may include a soft foam or rubber on the inner surface of the claims, to aid in holding the item as well as to prevent the clamps from chipping or otherwise damaging the edges of the device. In addition, the clams may also be flexible, to aid in fitting the clamps to the edges of the item to be secured. The clamps may be made from a flexible plastic or rubber material and are capable of some level of deformation. The suction cups 104, 106, 108, 202 (shown in FIG. 2) are attached to the rear surface of the base 102, allowing the base 102 to be secured in a resting position, and are retained by the retaining structure on the rear surface of the base 102. The device 100 is relatively simple, compact, lightweight and inexpensive, requiring little maintenance.

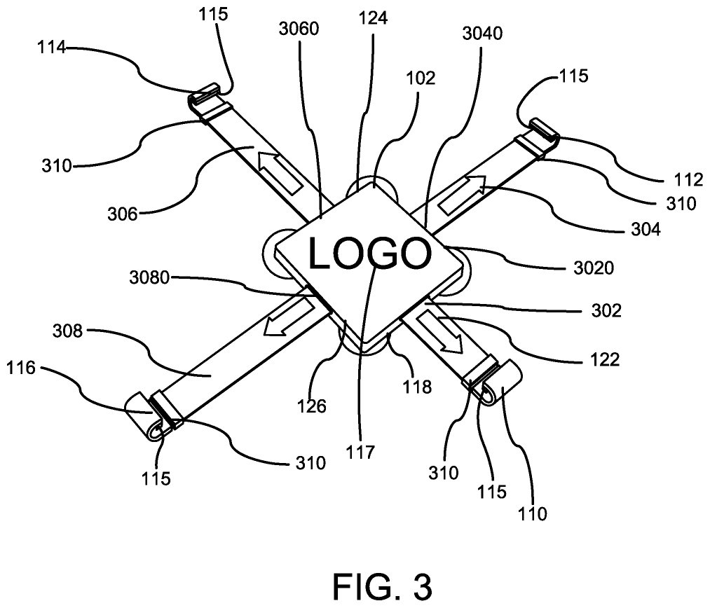

When the device 100 is not used for securing an object or item, the C-shaped clamps 110, 112, 114, 116 are secured to the respective side surfaces, and can be extended using an extendable and elastic band for securing any item. The top surface 102 of the device can include indicia, such as decorative indicia or brand indicia, including decorative indicia that relates to a particular occasion, such as a wedding, new baby, graduation, holiday, season, brand identifier, media format identifier or other visual design to promote a brand 117 (see e.g., FIG. 3). In certain embodiments, the top surface 102 could include a picture or a graphic, a character, art-piece, animal, or scene 119, relating to and readily identifiable as being associated with a company, movie, club or other business or charity entity.

FIG. 2 illustrates a bottom perspective view of one potential embodiment of the stabilizing support 100 of the present invention in accordance with the disclosed architecture, wherein the repositionable straps are in a first or stowed position. More specifically, the universal holder and stabilization device 100 has four symmetrical and similar-sized suction cups 104, 106, 108, 202 on the rear surface 204. The rear surface 204 can have apertures 107 acting as retaining structures on the rear surface 204. The suction cups 104, 106, 108, 202 allow the base 102 of the device 100 to be placed on a surface in a secure manner.

Each suction cup 104, 106, 108, 202 is generally concave-shaped to naturally trap air when placed on the surface. Each suction cup is sealed against a surface on which the suction cup is placed and air is squeezed out of the cup, creating a low pressure region inside the suction area and each cup is made of a flexible material, such as silicone. A suction is created due to the pressure difference between the atmospheric pressure outside the cup and the low pressure area inside the cup. The suction cups do not allow the base 120 to be knocked over and thus securing an item placed on the base 120 securely held by the device 100.

FIG. 3 illustrates a top perspective view of one potential embodiment of the stabilizing support 100 of the present invention in accordance with the disclosed architecture, wherein the repositionable straps are in a second or extended position. More specifically, each C-shaped clamp or hook 110, 112, 114, 116 is connected to a corresponding elastic and extendable band. Each C-shaped hook or clamp may have a soft foam or rubber material 115 to further assist in gripping the edge as well as to prevent the C-shaped hook from chipping the edge of the container or vessel. Each extendable band is connected to an internal spring and stop mechanism or brake present within the base 102.

A first C-shaped clamp 110 is connected to a first extendable band 302 with a connector 310. The first extendable band 302 can extend or retract through a first opening 3020 in the first side surface 118. Similarly, a second C-shaped clamp 112 is connected to a second extendable band 304 with the corresponding connector 310. The second extendable band 304 can extend or retract through a second opening 3040 in the second side surface 122. A third C-shaped clamp 114 is connected to a third extendable band 306 with a corresponding connector 310. The third extendable band 306 can extend or retract through a third opening 3060 in the third side surface 124. A fourth C-shaped clamp 116 is connected to a fourth extendable band 308 with a corresponding connector 310. The fourth extendable band 308 can extend or retract through a fourth opening 3080 in the fourth side surface 126.

Each extendable band 302, 304, 306, 308 can be pulled by a user to extend to a desired length, and is retracted automatically such that the C-shaped clamp 110 abuts to the first side surface 118, the C-shaped clamp 112 abuts to the second side surface 122, the C-shaped clamp 114 abuts to the third side surface 124, and the C-shaped clamp 116 abuts to the fourth side surface 126 of the base 102. The bands may be extended to variable lengths in order to accommodate different sizes of items to be held to the base. For example, some bands may extend out a greater distance than other bands, in order to cover the sides of an item which may be taller or higher than other sides.

The base 102 has a retraction spiral spring for each elastic and extendable band 302, 304, 306, 308 to automatically retract the bands when the extendable bands are not used. On retraction, each C-shaped clamp or hook abuts to the corresponding side surface of the base 102. Each extendable band 302, 304, 306, 308 is sturdy, flexible and can be extended up to 10″ in the preferred embodiment.

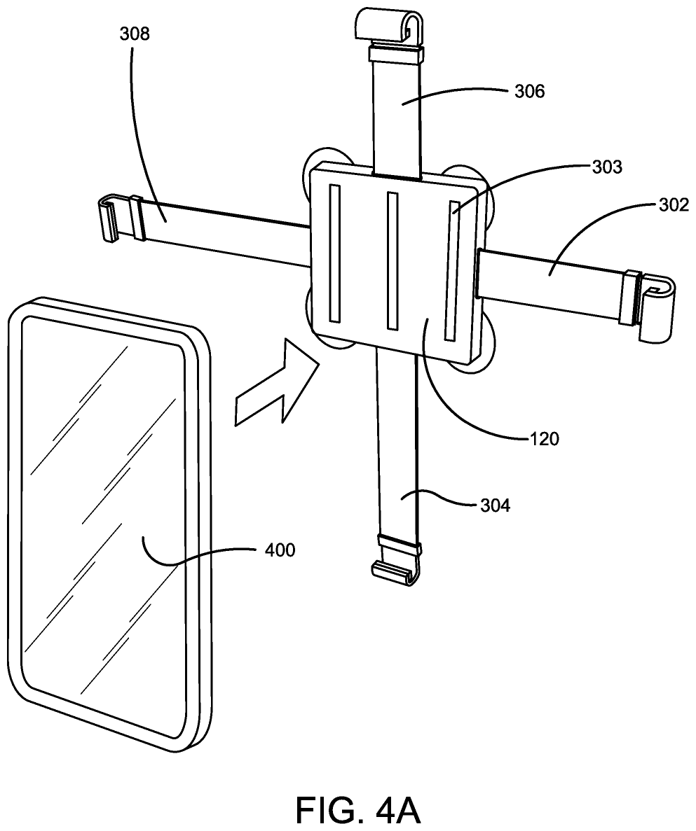

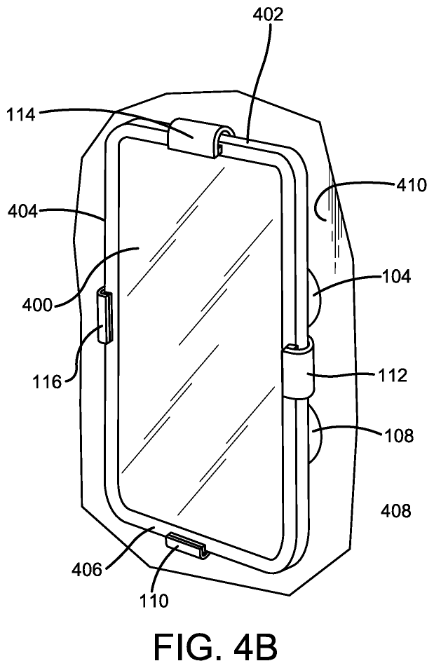

FIG. 4A illustrates a perspective view of one potential embodiment of the stabilizing support 100 of the present invention in accordance with the disclosed architecture, wherein the repositionable straps are in a second or extended position and about to receive a smartphone or other electronic device. More specifically, to secure an electronic device 400 such as a smartphone to the holding device 100 of the present invention, the extendable bands 302, 304, 306, 308 are extended according to the dimensions of the smartphone 400, with some bands being extended a greater amount than others and the smartphone 400 is placed on the top surface 120 of the base 102. The C-shaped clamps hook to the edges of the smartphone to securely hold the smartphone 400.

FIG. 4B illustrates a perspective view of one potential embodiment of the stabilizing support 100 of the present invention in accordance with the disclosed architecture, wherein the support 100 is securing the smartphone 400 of FIG. 4A. More specifically, the suction cups 104, 106, 108, 202 are provided at the rear surface of the base of the holding device 100 and are secured to a wall 410 with the smartphone 400 placed on the top surface, and secured by the C-shaped clamps. The C-shaped clamp 110 securely fits onto the edge 406 of the smartphone with a secure grip, and the C-shaped clamp 112 securely fits onto the edge 408, the C-shaped clamp 114 securely fits onto the edge 402 and the C-shaped clamp 116 securely fits onto the edge 404 to securely hold the smartphone 400. It should be noted that although in the present embodiment, the smartphone 400 is held in portrait mode, but securing the smartphone 400 in the landscape mode is also possible with the device 100 of the present invention.

The C-shaped clamps or hooks are made of high-quality plastic and have soft non-slipping pads, which do not scratch the holding items. The base of the device 100 is solid and rugged with non-slip rubber on the top surface, and may additionally be provided with grooves or another gripping pattern or a light tack adhesive 303 to help in holding the device when secured to the surface. The base provides stability and precise balance to the holding item.

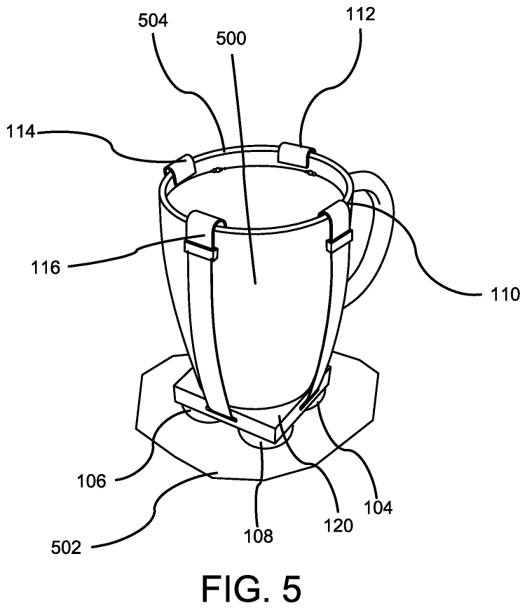

FIG. 5 illustrates a perspective view of one potential embodiment of the stabilizing support 100 of the present invention in accordance with the disclosed architecture, wherein the support 100 is securing a cup holding a beverage. More specifically, a cup 500 is placed on the top surface 120 of the base 102 for secure retainment by the holding device 100. The holding device 100 is placed on planar surface 502, such as a table or desk, using the suction cups 104, 106, 108, 202. Once the holding device 100 is securely placed on the surface 502 and the cup 500 is placed on the top surface 120, then the extendable bands are stretched to clamp or secure the C-shaped clamps on the rim 504 of the cup 500. Each C-shaped hook 110, 112, 114, 116 clamps onto the rim 504 securely such that cup 500 remains upright, and the drink in the cup is not spilled. The cup 500 is not knocked over and the device 100 secures a food or beverage item within four adjustable C-shaped clamps.

The four extendable bands connected to the hooks maintain the balance of the cup 500 or any other object on the base and help in centering the item on the base. Each of the bands are made of a material with elastic properties such as Spandex®, stretchable polyester, rubber or the like. It should be noted that the elasticity, strength, retraction force is same for each of the extendable bands and the retention spring for each extendable band is of same material and capacity and each applies sufficient and equal force to maintain a centering force on the item secured on the base.

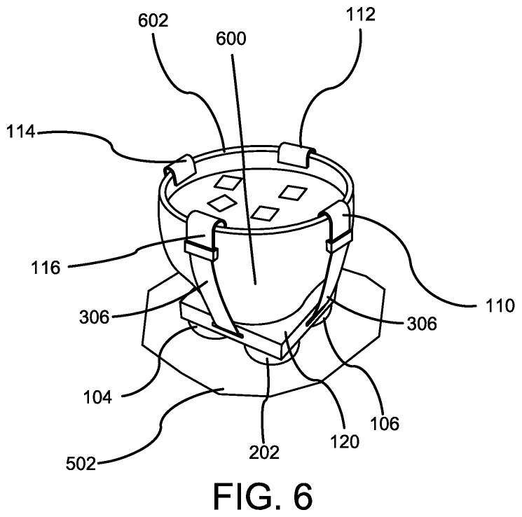

FIG. 6 illustrates a perspective view of one potential embodiment of the stabilizing support 100 of the present invention in accordance with the disclosed architecture, wherein the support 100 is securing a mug holding a beverage. More specifically, a mug 600 is placed on the top surface 120 of the base 102 for secure retainment by the holding device 100. The holding device 100 is placed on planar surface 502, using the suction cups 104, 106, 108, 202. Once the holding device 100 is securely placed on the surface 502, and the mug 600 is placed on the top surface 120, then the extendable bands 302, 304, 306, 308 are stretched to clamp or secure the C-shaped clamps on the rim 602 of the cup 500 and apply a centering force to hold the mug in a central position on the base. Each C-shaped hook 110, 112, 114, 116 clamps onto the rim 602 securely, such that the mug 600 remains upright, and the drink in the mug 600 is not spilled. The adaptor device 100 secures a food or beverage item within four adjustable C-shaped clamps. The four extendable bands 302, 304, 306, 308 connected to the hooks maintain the balance and centering of the mug 600 or any other object.

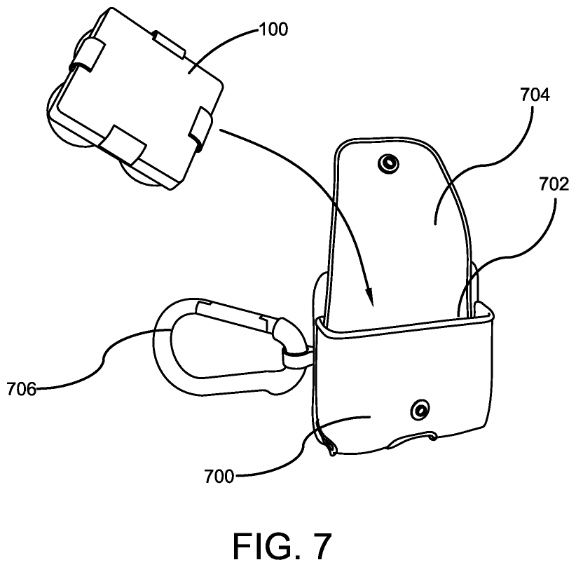

FIG. 7 illustrates a perspective view of one potential embodiment of the stabilizing support 100 of the present invention in accordance with the disclosed architecture and an accompanying carrying case. More specifically, the stabilizing device 100 is relatively compact, lightweight, portable and comes with a carry bag 700. The carry bag 700 is dimensioned as per the size of the holding device 100 and also includes a handle 706 for easy handling. An opening in the bag 702 receives the device 100 and a flap 704 secures the device 100. Any conventional design of the bag 700 is covered under the present invention, and carries the device 100 conveniently.

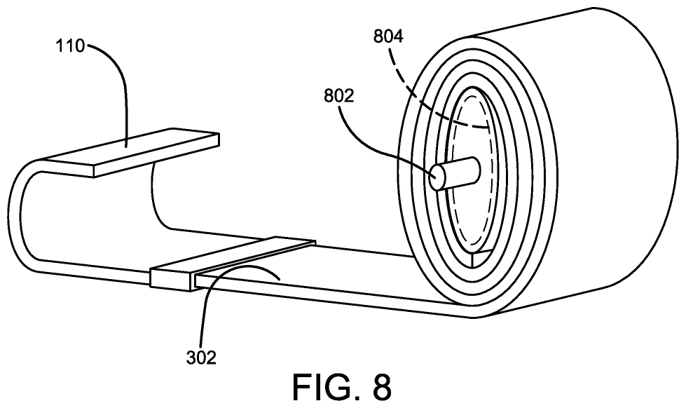

FIG. 8 illustrates a perspective view of one potential embodiment of the spring mechanism of the stabilizing support 100 of the present invention in accordance with the disclosed architecture. More specifically, the mechanism for retraction can be the same for each extendable band used in the holding apparatus 100 of the present invention. As an example, the extendable band 302 is rolled in the form of a thin spool around a spring 804 wrapped around a spindle 802. It should be noted that the spring 804 can be a horizontal spring to keep the height of the apparatus 100 minimum. When the extendable band 302 is used in an extended form, the spring 804 maintains/stores the energy and automatically retracts the band 302 by releasing the energy. The band 302 is stored in the form of a spool when retracted after each use.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “universal storage and stabilization device”, “multipurpose adapter system”, “stabilizing holder”, “holding device”, “adapter device” and “suction cup based item holder” are interchangeable and refer to the stabilizing support device 100 of the present invention.

Notwithstanding the forgoing, the stabilizing support device 100 of the present invention can be of any suitable size and configuration as is known in the art without affecting the overall concept of the invention, provided that it accomplishes the above-stated objectives. One of ordinary skill in the art will appreciate that the size, configuration and material of the stabilizing support device 100 as shown in the FIGS. are for illustrative purposes only, and that many other sizes and shapes of the stabilizing support device 100 are well within the scope of the present disclosure. Although the dimensions of the stabilizing support device 100 are important design parameters for user convenience, the stabilizing support device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A stabilizing support for an item, the stabilizing support comprising;
a base having a top surface, bottom surface and side surfaces;
each of the side surfaces having an extensible band;
the bottom surface having one or more suction cups for holding the base to a surface; and
each band having a first end and a second end, with the first end having a hook and the second end connected to the side surface;

2. The support as recited in claim 1, wherein each of bands apply a centering force to position an item centrally of the base.

3. The support as recited in claim 1, wherein each hook is provided with a soft foam or rubber gripping material.

4. The support as recited in claim 1, wherein the base is provided with a gripping surface.

5. The support as recited in claim 4, wherein the gripping surface includes grooves or a pattern.

6. The support as recited in claim 4, wherein the gripping surface includes a light tack adhesive.

7. The support as recited in claim 1, wherein each of the bands has elastic properties.

8. The support as recited in claim 1, wherein the base is geometrically shaped.

9. The support as recited in claim 1, each of the bands are centrally disposed in the sides.

10. The support as recited in claim 9, wherein each of the bands have a brake and a spring mechanism to form each band into a coil.

11. The support as recited in claim 1, wherein each of the suction cups are held in recesses of the base.

12. A square base platform for holding consumer items, comprising;
a square base having a top and a bottom surface and four sides;
four bands, with each of the bands having first and second end and the second end of each band is attached to one of the four sides and the first end of each of the elastic bands having a hook;
each band having a brake and a spring to form the band into a coil; and
the bottom surface of the square base having four suction cups.

13. The square base platform as recited in claim 1, wherein each of the bands have an elastic property.

14. The square base platform as recited in claim 13, wherein the bands provide a centering force to an item place on the top surface of the square base.

15. The square base platform as recited in claim 14, wherein the top surface of the square base platform has a non-slip surface.

16. The square base platform as recited in claim 12, wherein each hook on each of the bands has a soft foam or rubber material for gripping.

17. The square base platform as recited in claim 16, wherein each hook is made from a flexible material.

18. A consumer product holding device, comprising;
a base having a top surface, bottom surface and side surfaces;
a consumer product;
the base sized and configured to hold the consumer product;
a plurality of extensible bands, the plurality of extensible bands are attached to the side surfaces of the base;
each of the plurality of extensible bands having a first end and a second end, with the first end having a hook and the second end connected to a spring and brake mechanism for forming a coil; and
the plurality of extensible bands providing a centering force for holding the consumer product on the base.

19. The consumer product holding device as recited in claim 18, wherein each of the hooks has a soft foam or rubber material to hold the consumer product on the base.

20. The consumer product holding device as recited in claim 18, wherein the base has a non-slip surface.
